(19) United States
(12) Patent Application Publication
(10) Pub. No.: US 2023/0023457 A1
(43) Pub. Date: Jan. 26, 2023

(54) VEHICLE CAMERA DEVICE

(71) Applicant: KABUSHIKI KAISHA TOKAI-RIKA-DENKI-SEISAKUSHO, Niwa-gun, Aichi-ken (JP)

(72) Inventors: Ryusuke SADAMATSU, Niwa-gun, Aichi (JP); Masakazu IWATSUKI, Niwa-gun, Aichi (JP); Kenichi SUGISAKA, Niwa-gun, Aichi (JP); Tomonori ICHIKAWA, Niwa-gun, Aichi (JP); Takehiro HAMADA, Niwa-gun, Aichi (JP); Tomohiro NAKAO, Niwa-gun, Aichi (JP); Suguru FUJISAKI, Niwa-gun, Aichi (JP)

(21) Appl. No.: 17/788,194

(22) PCT Filed: Dec. 10, 2020
(86) PCT No.: PCT/JP2020/046150

§ 371 Date: Jun. 22, 2022

(30) Foreign Application Priority Data
Dec. 25, 2019 (JP) 2019-234613

(51) Int. Cl. B60R 1/12; B60R 11/04; H04N 5/225

(52) U.S. Cl. CPC B60R 1/12; B60R 11/04; H04N 5/2252; H04N 5/2257; B60R 2001/1253; B60R 2011/004

(57) ABSTRACT

In a vehicle camera device, engaging claws of a base are passed through through-holes of a camera mechanism and insertion pins of a second cover are inserted in insertion holes that are within the engaging claws, such that the through-holes are positioned with respect to the engaging claws and the insertion pins are positioned with respect to the insertion holes. Therefore, the camera mechanism and the second cover can be positioned with respect to the base, and a lens of the camera mechanism and an opening of the second cover can be aligned well.

### TECHNICAL FIELD

The present invention relates to a vehicle camera device in which a camera mechanism captures images of the outer side of an opening of a covering body via a lens.

### BACKGROUND ART

In the rearward viewing mirror disclosed in Japanese Patent Application Laid-Open (JP-A) No. 2009-512580, a casing covers an image detecting device, and the image detecting device captures images of the outer side of the opening of the casing via a lens.

Here, in this rearward viewing minor device, it is preferable to be able to well align the lens of the image detecting device and the opening of the casing.

### SUMMARY OF INVENTION

### Technical Problem

In view of the above-described circumstances, an object of the present invention is to provide a vehicle camera device in which a lens of a camera mechanism and an opening of a covering body can be aligned well.

### Solution to Problem

A vehicle camera device of a first aspect of the present invention comprises: a supporting body that is supported at a vehicle body side, and at which is provided an engaging portion in which an insertion hole is provided; a camera mechanism at which a lens is provided, and in which is provided a through-hole through which the engaging portion passes; and a covering body at which is provided an insertion portion, which is inserted in the insertion hole such that the through-hole is positioned with respect to the engaging portion and the insertion portion is positioned with respect to the insertion hole, an opening being provided in the covering body, the covering body covering the camera mechanism, and the camera mechanism capturing images of an outer side of the opening through the lens.

In a vehicle camera device of a second aspect of the present invention, in the vehicle camera device of the first aspect of the present invention, a plurality of each of the engaging portion, the through-hole and the insertion portion is provided.

In a vehicle camera device of a third aspect of the present invention, in the vehicle camera device of the first aspect or the second aspect of the present invention, the insertion hole and the through-hole are disposed coaxially.

A vehicle camera device of a fourth aspect of the present invention comprises: a supporting body that is supported at a vehicle body side, and at which an insertion portion is provided; a camera mechanism at which a lens is provided and in which a through-hole is provided; and a covering body at which is provided an engaging portion that is passed through the through-hole and in which an insertion hole is provided, an opening being provided in the covering body, the insertion portion being inserted in the insertion hole such that the insertion hole is positioned with respect to the insertion portion and the through-hole is positioned with respect to the engaging portion, the covering body covering the camera mechanism, and the camera mechanism capturing images of an outer side of the opening through the lens.

### Advantageous Effects of Invention

In the vehicle camera device of the first aspect of the present invention, the supporting body is supported at the vehicle body side. Further, the covering body covers the camera mechanism, and the camera mechanism captures images of the outer side of the opening of the covering body through the lens.

Here, the engaging portion of the supporting body is passed through the through-hole of the camera mechanism. The insertion portion of the covering body is inserted in the insertion hole of the engaging portion, such that the through-hole is positioned with respect to the engaging portion and the insertion portion is positioned with respect to the insertion hole. Therefore, the camera mechanism (the through-hole) and the covering body (the insertion portion) can be positioned with respect to the supporting body (the engaging portion and the insertion hole), and the camera mechanism and the covering body can be aligned well, and the lens of the camera mechanism and the opening of the covering body can be aligned well.

In the vehicle camera device of the second aspect of the present invention, a plurality of each of the engaging portion of the supporting body, the through-hole of the camera mechanism, and the insertion portion of the covering body is provided. Therefore, the camera mechanism and the covering body can be aligned even better, and the lens of the camera mechanism and the opening of the covering body can be aligned even better.

In the vehicle camera device of the third aspect of the present invention, the insertion hole of the engaging portion of the supporting body and the through-hole of the camera mechanism are disposed coaxially. Therefore, due to the insertion portion of the covering body being inserted in the insertion hole, the through-hole can be positioned appropriately with respect to the engaging portion.

### BRIEF DESCRIPTION OF DRAWINGS

FIG. 1 is a front view that is seen from a vehicle rear side and illustrates a vehicle camera device relating to a first embodiment of the present invention.

FIG. 2 is a cross-sectional view (a cross-sectional view along line 2-2 of FIG. 1) that is seen from an upper side and illustrates a camera mechanism of the vehicle camera device relating to the first embodiment of the present invention.

FIG. 3A is a cross-sectional view that is seen from above and illustrates a state before the assembly of a base cover to a base in the vehicle camera device relating to the first embodiment of the present invention.

FIG. 3B is a cross-sectional view that is seen from above and illustrates a state after the assembly of the base cover to the base in the vehicle camera device relating to the first embodiment of the present invention.

FIG. 4 is an exploded sectional view that is seen from above and illustrates a vehicle camera device relating to a second embodiment of the present invention.

FIG. 5 is a cross-sectional view that is seen from above and illustrates a vehicle camera device relating to a third embodiment of the present invention.

FIG. 6 is a cross-sectional view that is seen from above and illustrates main portions of a vehicle camera device relating to a fourth embodiment of the present invention.

### DESCRIPTION OF EMBODIMENTS

### First Embodiment

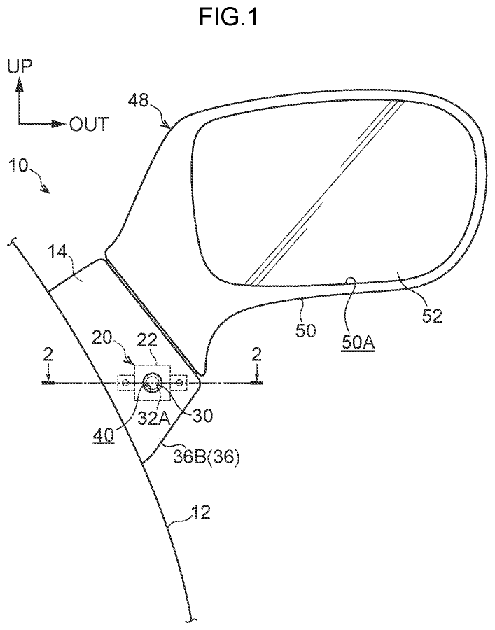

A vehicle camera device 10 relating to a first embodiment of the present invention is illustrated in FIG. 1 in a front view seen from the vehicle rear side. Note that, in the drawings, the vehicle forward direction is indicated by arrow FR, a vehicle transverse direction outer side (the vehicle right side) is indicated by arrow OUT, and the upward direction is indicated by arrow UP.

As illustrated in FIG. 1, the vehicle camera device 10 relating to the present embodiment is disposed at a vertical direction intermediate portion and the vehicle front side end of a side door 12 (in particular, a front side door) that serves as the vehicle body side of the vehicle, and is disposed at the outer side of the vehicle.

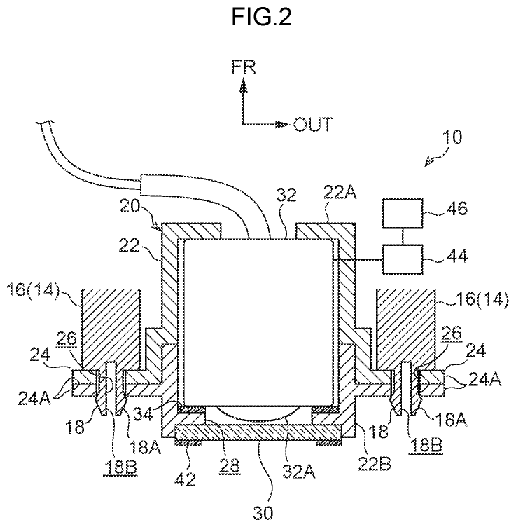

A base 14 (see FIG. 2), which is substantially shaped as a block and is made of resin and serves as a supporting body, is provided at the vehicle camera device 10. Due to the base 14 being fixed to the side door 12, the vehicle camera device 10 is disposed at the side door 12.

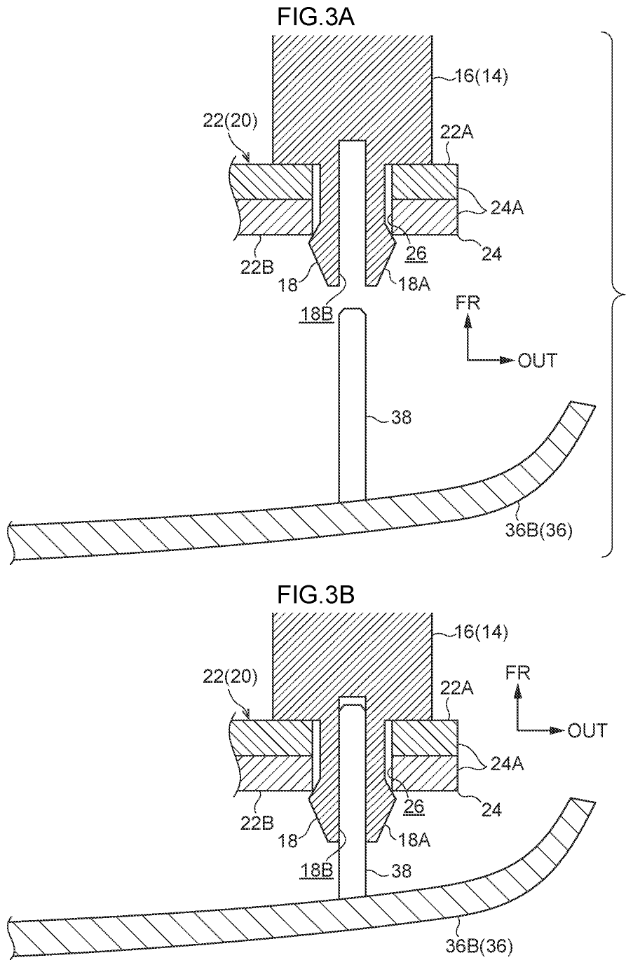

A pair of supporting pillars 16 (see FIG. 3A and FIG. 3B), which are shaped as rectangular pillars and serve as supporting portions, are formed integrally with the vehicle rear side portion of the base 14. The pair of supporting pillars 16 are apart from one another in the vehicle transverse direction, and the respective vehicle rear side surfaces thereof are disposed orthogonally to the vehicle longitudinal direction.

An engaging claw 18, which is substantially shaped as a cylindrical tube and serves as an engaging portion, is formed integrally with the vehicle rear side surface of each supporting pillar 16, and the engaging claw 18 extends out toward the vehicle rear side. A claw portion 18A that is triangular in cross-section is formed integrally with the outer periphery of the vehicle rear side portion of the engaging claw 18, over the entire periphery thereof. The claw portion 18A projects out toward the radial direction outer side of the engaging claw 18. The engaging claw 18 (including the claw portion 18A) is divided at a uniform interval in the peripheral direction and separated into plural (e.g., 2) sections, and the engaging claw 18 can elastically deform toward the radial direction inner side. An insertion hole 18B that is shaped as a solid cylinder is formed coaxially at the interior of the engaging claw 18, and the insertion hole 18B extends to the interior of the supporting pillar 16.

A camera mechanism 20 (see FIG. 2) is assembled to the base 14.

A bracket 22, which is substantially shaped as a rectangular parallelepiped box and serves as an accommodating body, is provided at the camera mechanism 20. The bracket 22 is structured by a first bracket 22A that serves as a first accommodating member and is at the vehicle front side, and a second bracket 22B that serves as a second accommodating member and is at the vehicle rear side, being assembled together (fit together).

A pair of through-plates 24, which are shaped as rectangular plates and serve as through-portions (see FIG. 3A and FIG. 3B), are formed integrally with the outer periphery of the bracket 22. The pair of through-plates 24 are apart from one another in the vehicle transverse direction. The through-plates 24 project out toward the radial direction outer side of the bracket 22, and are disposed orthogonally to the vehicle longitudinal direction. The through-plates 24 are structured by pair of through-pieces 24A that are shaped as rectangular plates being made to overlap one another in the vehicle longitudinal direction. The through-piece 24A at the vehicle front side is formed integrally with the first bracket 22A, and the through-piece 24A at the vehicle rear side is formed integrally with the second bracket 22B.

A through-hole 26 that is circular is formed so as to pass through each of the through-plates 24 (each pair of the through-pieces 24A). The engaging claw 18 of the base 14 is elastically deformed toward the radial direction inner side, and is coaxially passed through the through-hole 26. The vehicle rear side end of the peripheral surface of the through-hole 26 is fit together with the vehicle front side surface of the claw portion 18A of the engaging claw 18. The vehicle front side surface of the through-plate 24 is made to abut (planarly contact) the vehicle rear side surface of the supporting pillar 16 of the base 14. The through-plate 24 is nipped between the vehicle front side surface of the claw portion 18A and the vehicle rear side surface of the supporting pillar 16. Due thereto, the through-plates 24 (the through-holes 26) are held by the engaging claws 18, and the bracket 22 is held at the base 14.

The vehicle rear side wall of the bracket 22 (the vehicle rear side wall of the second bracket 22B) is provided adjacent to the vehicle rear side end portion of the bracket 22. An opening hole 28 that is circular is formed so as to coaxially pass through the vehicle rear side wall of the bracket 22. The opening hole 28 opens the interior of the bracket 22 to the vehicle rear side. A glass cover 30, which is shaped as a rectangular plate and serves as a transmitting member, is coaxially fit together with and fixed to the interior of the vehicle rear side end portion of the bracket 22. The glass cover 30 is transparent and can transmit light therethrough.

A camera 32 that is substantially shaped as a rectangular pillar is fixed within the bracket 22 (within the first bracket 22A), and is accommodated coaxially within the bracket 22. A lens 32A is provided coaxially at the vehicle rear side end portion of the camera 32. The lens 32A is exposed to the vehicle rear side, and is disposed coaxially with the opening hole 28 of the bracket 22 and the glass cover 30.

An inner double-sided tape 34, which is shaped as a frame-like plate and serves as an adhesive member, is coaxially affixed to the vehicle rear side surface of the camera 32. The interior of the inner double-sided tape 34 is circular, and exposes the lens 32A of the camera 32 at the vehicle rear side (the opening hole 28 side of the bracket 22). The outer shape of the inner double-sided tape 34 is rectangular, and the inner double-sided tape 34 is affixed coaxially to the vehicle rear side wall of the bracket 22.

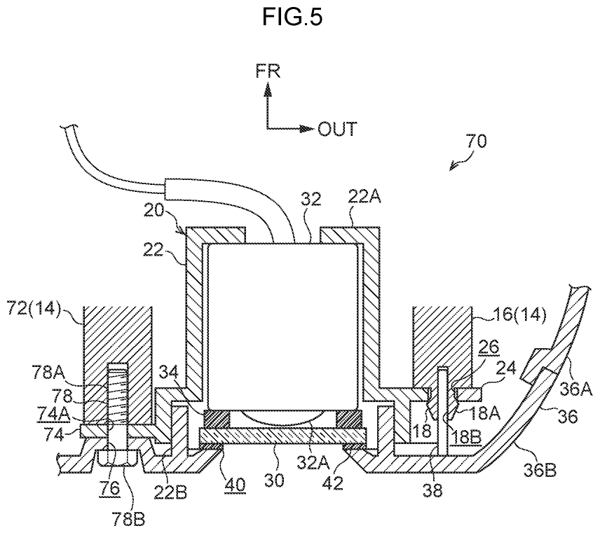

The base 14 and the camera mechanism 20 are covered by a base cover 36 that is substantially shaped as a cylindrical tube, is made of resin and serves as a covering body. The base cover 36 is fixed to the base 14. The base cover 36 is structured by a first cover 36A (see FIG. 5) that serves as a first covering member and is at the vehicle front side, and a second cover 36B (see FIG. 3A and FIG. 3B) that serves as a second covering member and is at the vehicle rear side, being assembled together (fit together).

A pair of insertion pins 38, which are shaped as solid cylinders and serve as insertion portions, are formed integrally with the interior of the second cover 36B. The pair of insertion pins 38 are apart from one another in the vehicle transverse direction, and respectively extend out toward the vehicle front side. The insertion pins 38 are inserted coaxially into the insertion holes 18B that are within the engaging claws 18 of the base 14. The insertion pins 38 are fit together with the insertion holes 18B in the radial direction, and restrict elastic deformation of the engaging claws 18 toward the radial direction inner sides. Due thereto, sliding of the through-holes 26 (the through-plates 24) of the camera mechanism 20 (the bracket 22) in the vertical direction, the vehicle transverse direction and the vehicle longitudinal direction is restricted by the engaging claws 18, and rotation of the through-hole 26 around the engaging claw 18 is restricted by the other through-hole 26 and engaging claw 18, such that the through-holes 26 are positioned in the vertical direction, the vehicle transverse direction and the vehicle longitudinal direction with respect to the engaging claws 18. Due thereto, the first bracket 22A and the second bracket 22B of the bracket 22 are fixed, and the bracket 22 is fixed to the base 14. Moreover, sliding of the insertion pins 38 in the vertical direction and the vehicle transverse direction is restricted by the insertion holes 18B, and rotation of the insertion pin 38 around the insertion hole 18B is restricted by the other insertion pin 38 and insertion hole 18B, such that the insertion pins 38 are positioned in the vertical direction and the vehicle transverse direction with respect to the insertion holes 18B.

An opening 40 (see FIG. 5) that is circular is formed to pass through the second cover 36B, and the opening 40 opens the interior of the second cover 36B to the vehicle rear side. An outer double-sided tape 42, which is shaped as a frame-like plate and serves as an adhesive member, is affixed to the inner surface of the second cover 36B at the outer side of the outer periphery of the opening 40. The interior of the outer double-sided tape 42 is circular, and is disposed coaxially with the opening 40. The outer shape of the outer double-sided tape 42 is rectangular, and the outer double-sided tape 42 is affixed coaxially to the glass cover 30 of the bracket 22. The interior of the outer double-sided tape 42 is disposed coaxially with the lens 32A of the camera 32. The diameter dimension of the interior of the outer double-sided tape 42 is made to be large as compared with the diameter dimension of the opening hole 28 of the bracket 22. The outer double-sided tape 42 is elastic and sealing, and seals the region between the glass cover 30 and the outer side of the outer periphery of the opening 40 of the second cover 36B. The outer double-sided tape 42 limits the penetration of moisture into the second cover 36B through the opening 40.

The opening 40 of the second cover 36B coaxially faces the lens 32A of the camera 32 through the glass cover 30. The camera 32 can capture images of the vehicle rear side (the outer side of the opening 40 of the base cover 36) through the opening 40, the glass cover 30 and the lens 32A. The camera 32 is electrically connected to a control device 44 of the vehicle, and, due to control of the control device 44, captures images of the vehicle rear side. A monitor 46 serving as a display mechanism is electrically connected to the control device 44. Due to control of the control device 44, the monitor 46 displays the images captured by the camera 32. The monitor 46 is set within the vehicle cabin, and, due to an occupant of the vehicle (the driver in particular) viewing the images displayed on the monitor 46, viewing by the vehicle occupant of the vehicle rear side is assisted.

The base cover 36 exposes the base 14 to the vehicle upper side. A mirror mechanism 48 is supported at the vehicle upper side of the base 14. A visor 50 that is substantially shaped as a rectangular parallelepiped box is provided at the mirror mechanism 48. An exposing hole 50A that is substantially rectangular is formed so as to pass through the vehicle rear side wall of the visor 50. A mirror 52 that is substantially shaped as a rectangular plate is disposed within the exposing hole 50A, and the mirror 52 is supported within the visor 50. The obverse side surface of the mirror 52 is exposed from the exposing hole 50A to the vehicle rear side. Viewing of the vehicle rear side by a vehicle occupant is assisted due to the vehicle occupant viewing the light reflected by the mirror 52 from the obverse side of the mirror 52.

Operation of the present embodiment is described next.

In the vehicle camera device 10 of the above-described structure, the base cover 36 covers the base 14 and the camera mechanism 20. At the camera mechanism 20, the camera 32 captures images of the vehicle rear side through the opening 40 of the base cover 36, the glass cover 30 of the bracket 22, and the lens 32A of the camera 32.

By the way, at the time when the camera mechanism 20 and the base cover 36 are assembled to the base 14, the engaging claws 18 of the base 14 (the supporting pillars 16) are passed through the through-holes 26 of the through-plates 24 of the bracket 22 (the through-pieces 24A of the first bracket 22A and the second bracket 22B) (see FIG. 2 and FIG. 3A). Therefore, the vehicle rear side ends of the peripheral surfaces of the through-holes 26 are fit together with the vehicle front side surfaces of the claw portions 18A of the engaging claws 18, and the vehicle front side surfaces of the through-plates 24 are made to abut the vehicle rear side surfaces of the supporting pillars 16 of the base 14, and the through-plates 24 are nipped between the vehicle front side surfaces of the claw portions 18A of the engaging claws 18 and the vehicle rear side surfaces of the supporting pillars 16.

Then, the base 14 and the camera mechanism 20 are covered by the base cover 36 (the first cover 36A and the second cover 36B). At the time when the base 14 and the camera mechanism 20 are covered by the second cover 36B, the insertion pins 38 of the second cover 36B are inserted into and fit together with the insertion holes 18B that are within the engaging claws 18, such that elastic deformation of the engaging claws 18 toward the radial direction inner sides is restricted by the insertion pins 38 (see FIG. 3B). Therefore, sliding of the through-holes 26 (the through-plates 24) in the vertical direction, the vehicle transverse direction and the vehicle longitudinal direction is restricted by the engaging claws 18, and rotation of the through-hole 26 around the engaging claw 18 is restricted by the other through-hole 26 and engaging claw 18, such that the through-holes 26 are positioned in the vertical direction, the vehicle transverse direction and the vehicle longitudinal direction with respect to the engaging claws 18. Due thereto, the first bracket 22A and the second bracket 22B of the bracket 22 are fixed, and the bracket 22 is fixed to the base 14. Moreover, sliding of the insertion pins 38 in the vertical direction and the vehicle transverse direction is restricted by the insertion holes 18B, and rotation of the insertion pin 38 around the insertion hole 18B is restricted by the other insertion pin 38 and insertion hole 18B, such that the insertion pins 38 are positioned in the vertical direction and the vehicle transverse direction with respect to the insertion holes 18B. Further, at the time when the base 14 and the camera mechanism 20 are covered by the second cover 36B, the outer double-sided tape 42 is affixed to the outer side of the outer periphery of the opening 40 of the inner surface of the second cover 36B, and to the glass cover 30 of the bracket 22.

Thereafter, the base cover 36 is fixed to the base 14.

Here, as described above, the engaging claws 18 of the base 14 are passed through the through-holes 26 of the camera mechanism 20 (the bracket 22), the insertion pins 38 of the second cover 36B are inserted in the insertion holes 18B that are within the engaging claws 18, such that the through-holes 26 are positioned in the vertical direction and the vehicle transverse direction with respect to the engaging claws 18, and the insertion pins 38 are positioned in the vertical direction and the vehicle transverse direction with respect to the insertion holes 18B. Therefore, the camera mechanism 20 (the through-holes 26) and the second cover 36B (the insertion pins 38) can be positioned in the vertical direction and the vehicle transverse direction with respect to the same base 14 (the engaging claws 18 and the insertion holes 18B), and the camera mechanism 20 and the second cover 36B can be aligned well in the vertical direction and the vehicle transverse direction, and the lens 32A of the camera mechanism 20 and the opening 40 of the second cover 36B can be aligned well in the vertical direction and the vehicle transverse direction.

Moreover, the engaging claws 18 (including the insertion holes 18B) of the base 14, the through-holes 26 of the camera mechanism 20, and the insertion pins 38 of the second cover 36B are respectively provided as pairs. Therefore, the camera mechanism 20 and the second cover 36B can be aligned even better in the vertical direction and the vehicle transverse direction, and the lens 32A of the camera mechanism 20 and the opening 40 of the second cover 36B can be aligned even better in the vertical direction and the vehicle transverse direction.

Moreover, the insertion holes 18B are provided coaxially with the engaging claws 18 of the base 14, the engaging claws 18 are inserted coaxially in the through-holes 26 of the camera mechanism 20, such that the insertion holes 18B and the through-holes 26 are disposed coaxially. Therefore, due to the insertion pins 38 of the second cover 36B being inserted in the insertion holes 18B, the through-holes 26 can be positioned appropriately in the vertical direction and the vehicle transverse direction with respect to the engaging claws 18.

Further, due to the second cover 36B being assembled to the base 14, the insertion pins 38 of the second cover 36B are inserted in the insertion holes 18B that are within the engaging claws 18 of the base 14, such that the camera mechanism 20 (the bracket 22) is fixed to the base 14. Therefore, there is no need to fix the camera mechanism 20 to the base 14 separately from the assembling of the second cover 36B to the base 14, and the number of processes for assembling the camera mechanism 20 and the base cover 36 to the base 14 can be reduced.

Moreover, by removing the second cover 36B from the base 14, the insertion pins 38 of the second cover 36B are withdrawn from the insertion holes 18B that are within the engaging claws 18 of the base 14, such that the fixing of the camera mechanism 20 (the bracket 22) to the base 14 is cancelled. Then, due to elastic deformation of the engaging claws 18 toward the radial direction inner side, the through-holes 26 of the bracket 22 (at least the through-holes 26 of the second bracket 22B) are disengaged from the engaging claws 18, and the first bracket 22A and the second bracket 22B of the bracket 22 are separated. Due thereto, the inner double-sided tape 34 is detached from the vehicle rear side wall of the second bracket 22B or the camera 32 of the camera mechanism 20, such that the camera 32 is exposed to the exterior of the bracket 22. Therefore, by removing the second cover 36B from the base 14, the fixing of the camera mechanism 20 to the base 14 can be easily cancelled, and the camera 32 can be easily exposed to the exterior of the bracket 22, and maintenance of the camera 32 can be carried out easily.

### Second Embodiment

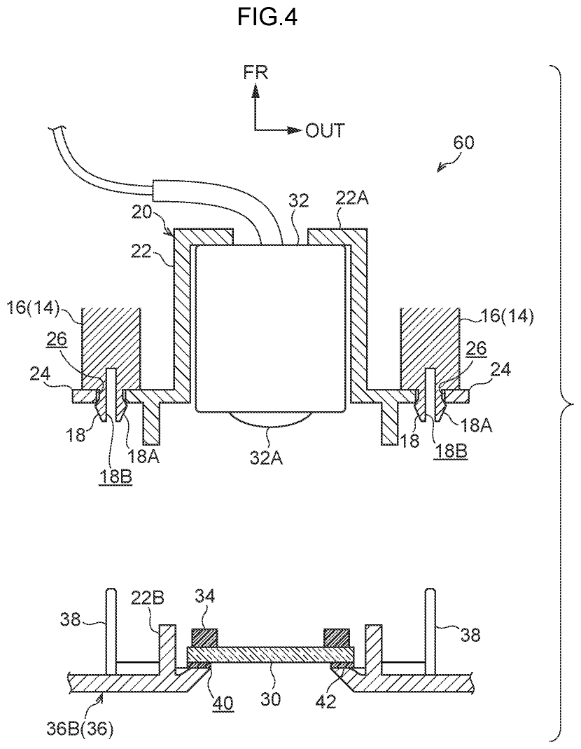

A vehicle camera device 60 relating to a second embodiment of the present invention is illustrated in FIG. 4 in an exploded sectional view seen from above.

The vehicle camera device 60 relating to the present embodiment has a structure that is substantially similar to that of the above-described first embodiment, but differs with regard to the following points.

As illustrated in FIG. 4, at the camera mechanism 20 of the vehicle camera device 60 relating to the present embodiment, the second bracket 22B of the bracket 22 is made integral with the second cover 36B of the base cover 36, and the second bracket 22B (including the glass cover 30) is made to be a portion of the second cover 36B.

The through-plates 24 of the bracket 22 are not divided into the pairs of through-pieces 24A, and the through-plates 24 (including the through-holes 26) are formed integrally with the first bracket 22A.

The vehicle rear side wall of the second bracket 22B is structured by the second cover 36B. The inner double-sided tape 34 is affixed coaxially to the glass cover 30 instead of the vehicle rear side wall of the bracket 22.

By the way, at the time of assembling the camera mechanism 20 and the base cover 36 to the base 14, the engaging claws 18 of the base 14 (the supporting pillars 16) are passed through the through-holes 26 of the through-plates 24 of the bracket 22 (the first bracket 22A) at the camera mechanism 20. Therefore, the vehicle rear side ends of the peripheral surfaces of the through-holes 26 are fit together with the vehicle front side surfaces of the claw portions 18A of the engaging claws 18, and the vehicle front side surfaces of the through-plates 24 are made to abut the vehicle rear side surfaces of the supporting pillars 16 of the base 14, such that the through-plates 24 are nipped between the vehicle front side surfaces of the claw portions 18A of the engaging claws 18 and the vehicle rear side surfaces of the supporting pillars 16.

Further, the base 14 and the camera mechanism 20 are covered by the base cover 36 (the first cover 36A and the second cover 36B (including the second bracket 22B)). At the time when the base 14 and the camera mechanism 20 are covered by the second cover 36B, the insertion pins 38 of the second cover 36B are inserted into and fit together with the insertion holes 18B that are within the engaging claws 18, such that elastic deformation of the engaging claws 18 toward the radial direction inner sides is restricted by the insertion pins 38. Therefore, sliding of the through-holes 26 (the through-plates 24) in the vertical direction, the vehicle transverse direction and the vehicle longitudinal direction is restricted by the engaging claws 18, and rotation of the through-hole 26 around the engaging claw 18 is restricted by the other through-hole 26 and engaging claw 18, such that the through-holes 26 are positioned in the vertical direction, the vehicle transverse direction and the vehicle longitudinal direction with respect to the engaging claws 18. Due thereto, the bracket 22 is fixed to the base 14. Moreover, sliding of the insertion pins 38 in the vertical direction and the vehicle transverse direction is restricted by the insertion holes 18B, and rotation of the insertion pin 38 around the insertion hole 18B is restricted by the other insertion pin 38 and insertion hole 18B, such that the insertion pins 38 are positioned in the vertical direction and the vehicle transverse direction with respect to the insertion holes 18B. Further, at the time when the base 14 and the camera mechanism 20 are covered by the second cover 36B, the outer double-sided tape 42 is adhered to the outer side of the outer periphery of the opening 40 of the inner surface of the second cover 36B and to the glass cover 30 of the second bracket 22B, and the inner double-sided tape 34 is affixed to the glass cover 30 and to the camera 32 of the camera mechanism 20.

Thereafter, the base cover 36 is fixed to the base 14.

Here, in the present embodiment as well, operation and effects that are similar to those of the above-described first embodiment can be obtained.

In particular, the second cover 36B is removed from the base 14, and the insertion pins 38 of the second cover 36B are withdrawn from the insertion holes 18B that are within the engaging claws 18 of the base 14, and the bracket 22 (the first bracket 22A) and the second cover 36B (the second bracket 22B) are separated. Due thereto, the inner double-sided tape 34 is detached from the camera 32 of the camera mechanism 20 or the glass cover 30 of the second bracket 22B, such that the camera 32 is exposed to the exterior of the bracket 22. Therefore, by removing the second cover 36B from the base 14, the camera 32 can be easily exposed to the exterior of the bracket 22, and maintenance of the camera 32 can be carried out easily.

### Third Embodiment

A vehicle camera device 70 relating to a third embodiment of the present invention is illustrated in FIG. 5 in a cross-sectional view seen from above.

The vehicle camera device 70 relating to the present embodiment has a structure that is substantially similar to that of the above-described second embodiment, but differs with regard to the following points.

As illustrated in FIG. 5, a fastening pillar 72, which is shaped as a rectangular pillar and serves as a fixing portion, is formed integrally with the base 14 of the vehicle camera device 70 relating to the present embodiment, instead of the one (the one at the vehicle transverse direction inner side in the present embodiment) supporting pillar 16 (including the engaging claw 18). The vehicle rear side surface of the fastening pillar 72 is disposed orthogonally to the vehicle longitudinal direction. The engaging claw 18 of the other (the one at the vehicle transverse direction outer side in the present embodiment) supporting pillar 16 is formed substantially in the shape of a rectangular tube (it suffices for the engaging claw 18 to be shaped as a noncircular tube). The insertion hole 18B that is within the engaging claw 18 is formed in the shape of a rectangular pillar (it suffices for the insertion hole 18B to be shaped as a noncircular pillar).

An insert-through plate 74, which is shaped as a rectangular plate and serves as an insert-through portion, is formed integrally with the bracket 22 (the first bracket 22A) of the camera mechanism 20, instead of the one (the one at the vehicle transverse direction inner side in the present embodiment) through-plate 24. An insert-through hole 74A that is circular is formed so as to pass through the insert-through plate 74. The through-hole 26 of the other (the one at the vehicle transverse direction outer side in the present embodiment) through-plate 24 is formed in a rectangular shape (it suffices for the through-hole 26 to be noncircular), and the engaging claw 18 of the base 14 is elastically deformed toward the radial direction inner side and passed coaxially through the through-hole 26. The vehicle rear side end of the peripheral surface of the through-hole 26 is fit together with the vehicle front side surface of the claw portion 18A of the engaging claw 18, and the vehicle front side surface of the through-plate 24 is made to abut (planarly contact) the vehicle rear side surface of the supporting pillar 16 of the base 14, such that the through-plate 24 is nipped between the vehicle front side surface of the claw portion 18A and the vehicle rear side surface of the supporting pillar 16. Due thereto, the through-plate 24 (the through-hole 26) is held by the engaging claw 18, and the bracket 22 is held by the base 14.

A fastening hole 76 that is circular is formed to pass through the second cover 36B (including the second bracket 22B) of the base cover 36, instead of the one (the one at the vehicle transverse direction inner side in the present embodiment) insertion pin 38. The other (the one at the vehicle transverse direction outer side in the present embodiment) insertion pin 38 is formed in the shape of a rectangular pillar (it suffices for the insertion pin 38 to be shaped as a noncircular pillar). The insertion pin 38 is inserted coaxially into the insertion hole 18B that is within the engaging claw 18 of the base 14. The insertion pin 38 is fit together with the insertion hole 18B in the radial direction, and restricts elastic deformation of the engaging claw 18 toward the radial direction inner side. Due thereto, sliding of the through-hole 26 (the through-plate 24) of the camera mechanism (the bracket 22) in the vertical direction, the vehicle transverse direction and the vehicle longitudinal direction, and rotation of the through-hole 26 around the engaging claw 18, are restricted by the engaging claw 18, such that the through-hole 26 is positioned in the vertical direction, the vehicle transverse direction and the vehicle longitudinal direction with respect to the engaging claw 18. Due thereto, the bracket 22 is fixed to the base 14. Moreover, sliding of the insertion pin 38 in the vertical direction and the vehicle transverse direction, and rotation of the insertion pin 38 around the insertion hole 18B, are restricted by the insertion hole 18B, such that the insertion pin 38 is positioned in the vertical direction and the vehicle transverse direction with respect to the insertion hole 18B.

A leg portion 78A of a screw 78 is coaxially inserted through and fit together with the insert-through hole 74A of the insert-through plate 74 of the bracket 22 and the fastening hole 76 of the second cover 36B. The leg portion 78A of the screw 78 is screwed together with the fastening pillar 72 of the base 14, such that the insert-through plate 74 and the second cover 36B are fastened to the fastening pillar 72 by the screw 78 (the insert-through plate 74 and the second cover 36B are nipped between a head portion 78B of the screw 78 and the vehicle rear side surface of the fastening pillar 72). Due thereto, sliding of the insert-through plate 74 (the insert-through hole 74A) of the camera mechanism 20 (the bracket 22) and the second cover 36B (the fastening hole 76) in the vertical direction, the vehicle transverse direction and the vehicle longitudinal direction is restricted by the screw 78.

By the way, at the time when the camera mechanism 20 and the base cover 36 are assembled to the base 14, the engaging claw 18 of the base 14 (the supporting pillar 16) is inserted through the through-hole 26 of the through-plate 24 of the bracket 22 (the first bracket 22A) at the camera mechanism 20. Therefore, the vehicle rear side end of the peripheral surface of the through-hole 26 is fit together with the vehicle front side surface of the claw portion 18A of the engaging claw 18, and the vehicle front side surface of the through-plate 24 is made to abut the vehicle rear side surface of the supporting pillar 16 of the base 14, such that the through-plate 24 is nipped between the vehicle front side surface of the claw portion 18A of the engaging claw 18 and the vehicle rear side surface of the supporting pillar 16.

Further, the base 14 and the camera mechanism 20 are covered by the base cover 36 (the first cover 36A and the second cover 36B (including the second bracket 22B)). At the time when the base 14 and the camera mechanism 20 are covered by the second cover 36B, the insertion pin 38 of the second cover 36B is inserted into and fit together with the insertion hole 18B that is within the engaging claw 18, such that elastic deformation of the engaging claw 18 toward the radial direction inner side is restricted by the insertion pin 38. Therefore, sliding of the through-hole 26 (the through-plate 24) in the vertical direction, the vehicle transverse direction and the vehicle longitudinal direction, and rotation of the through-hole 26 around the engaging claw 18, are restricted by the engaging claw 18, such that the through-hole 26 is positioned in the vertical direction, the vehicle transverse direction and the vehicle longitudinal direction with respect to the engaging claw 18. Due thereto, the bracket 22 is fixed to the base 14. Moreover, sliding of the insertion pin 38 in the vertical direction and the vehicle transverse direction, and rotation of the insertion pin 38 around the insertion hole 18B, are restricted by the insertion hole 18B, such that the insertion pin 38 is positioned in the vertical direction and the vehicle transverse direction with respect to the insertion hole 18B. Further, at the time when the base 14 and the camera mechanism 20 are covered by the second cover 36B, the outer double-sided tape 42 is affixed to the outer side of the outer periphery of the opening 40 of the inner surface of the second cover 36B and to the glass cover 30 of the bracket 22, and the inner double-sided tape 34 is affixed to the glass cover 30 and to the camera 32 of the camera mechanism 20.

Thereafter, the base cover 36 is fixed to the base 14. At the time of fixing the second cover 36B to the base 14, the leg portion 78A of the screw 78 is inserted through and fit together with the insert-through hole 74A of the insert-through plate 74 of the bracket 22 and the fastening hole 76 of the second cover 36B, and the leg portion 78A of the screw 78 is screwed together with the fastening pillar 72 of the base 14, such that the insert-through plate 74 and the second cover 36B are fastened to the fastening pillar 72 by the screw 78.

Here, in the present embodiment as well, operation and effects that are similar to those of the above-described second embodiment can be obtained other than the operation and effects that are due to providing the engaging claws 18 (including the insertion holes 18B) of the base 14, and the through-holes 26 of the camera mechanism 20, and the insertion pins 38 of the second cover 36B, as pairs respectively.

Note that, in the present embodiment, the present embodiment is applied to the above-described second embodiment. However, the present embodiment may be applied to the above-described first embodiment.

### Fourth Embodiment

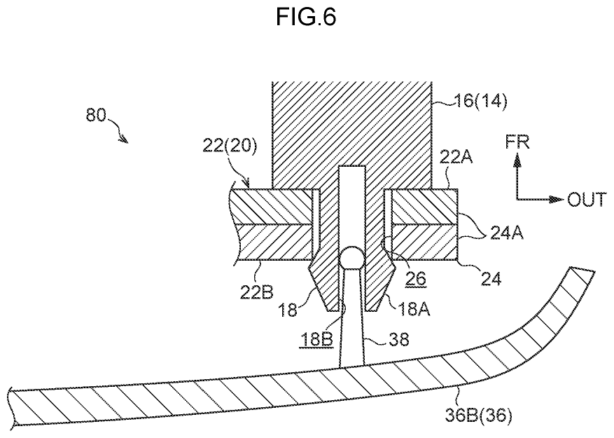

Main portions of a vehicle camera device 80 relating to a fourth embodiment of the present invention are illustrated in FIG. 6 in a cross-sectional view seen from above.

The vehicle camera device 80 relating to the present embodiment has a structure that is substantially similar to that of the above-described first embodiment, but differs with regard to the following points.

As illustrated in FIG. 6, at the base cover 36 (the second cover 36B) of the vehicle camera device 80 relating to the present embodiment, the diameters of the portions, which are other than the distal end portions (the vehicle front side end portions), of the insertion pins 38 gradually become smaller toward the vehicle front side, and the distal end portions of the insertion pins 38 are formed in substantially spherical shapes. The insertion pins 38 are inserted coaxially in the insertion holes 18B that are within the engaging claws 18 of the base 14, and the distal end portions of the insertion pins 38 are fit together with the insertion holes 18B in the radial direction. The positions at which the distal end portions of the insertion pins 38 fit together with the insertion holes 18B coincide, in the vehicle longitudinal direction (the axial direction of the insertion pins 38 and the insertion holes 18B), with the positions at which the vehicle rear side ends of the peripheral surfaces of the through-holes 26 of the camera mechanism 20 (the bracket 22) fit together with the vehicle front side surfaces of the claw portions 18A of the engaging claws 18. The distal end portions of the insertion pin 38 restrict elastic deformation of the engaging claws 18 toward the radial direction inner sides.

Here, in the present embodiment as well, operation and effects that are similar to those of the above-described first embodiment can be obtained.

Moreover, the substantially spherical distal end portions of the insertion pins 38 are fit together with the insertion holes 18B in the radial direction, and the positions at which the distal end portions of the insertion pins 38 are fit together with the insertion holes 18B coincide, in the vehicle longitudinal direction, with the positions at which the vehicle rear side ends of the peripheral surfaces of the through-holes 26 are fit together with the vehicle front side surfaces of the claw portions 18A of the engaging claws 18, such that the distal end portions of the insertion pins 38 restrict elastic deformation of the engaging claws 18 toward the radial direction inner sides. Therefore, even if the diameters of the insertion pins 38 are not made to be the same in the vehicle longitudinal direction, the insertion pins 38 can restrict elastic deformation of the engaging claws 18 toward the radial direction inner sides.

Note that, in the present embodiment, the present embodiment is applied to the above-described first embodiment. However, the present embodiment may be applied to the above-described second embodiment or third embodiment.

Further, in the above-described first embodiment, second embodiment and fourth embodiment, one of the engaging claws 18 restricts sliding, in the vertical direction and the vehicle transverse direction, of one of the through-holes 26 (through-plates 24), and the other engaging claw 18 restricts rotation of one of the through-holes 26 around one of the engaging claws 18, such that the through-holes 26 are positioned in the vertical direction and the vehicle transverse direction with respect to the engaging claws 18. However, one of the engaging claws 18 may restrict sliding in one direction of one of the through-holes 26 (through-plates 24), and the other engaging claw 18 may restrict sliding in another direction (a direction intersecting (e.g., orthogonal to) the one direction) of the another through-hole 26, such that the through-holes 26 may be positioned in the vertical direction and the vehicle transverse direction with respect to the engaging claws 18.

Moreover, in the above-described first embodiment, second embodiment and fourth embodiment, one of the insertion holes 18B restricts sliding in the vertical direction and the vehicle transverse direction of one of the insertion pins 38, and the other insertion hole 18B restricts rotation of one of the insertion pins 38 around one of the insertion holes 18B, such that the insertion pins 38 are positioned in the vertical direction and the vehicle transverse direction with respect to the insertion holes 18B. However, one of the insertion holes 18B may restrict sliding of one of the insertion pins 38 in one direction, and the other insertion hole 18B may restrict sliding of the other insertion pin 38 in another direction (a direction intersecting (e.g., orthogonal to) the one direction), such that the insertion pins 38 may be positioned in the vertical direction and the vehicle transverse direction with respect to the insertion holes 18B.

Further, in the above-described first embodiment, second embodiment and fourth embodiment, two of each of the supporting pillar 16, the engaging claw 18 (including the insertion hole 18B), the through-hole 26 and the insertion pin 38 are provided. However, three or more of each of the supporting pillar 16, the engaging claw 18 (including the insertion hole 18B), the through-hole 26 and the insertion pin 38 may be provided.

Moreover, in the above-described first embodiment through fourth embodiment, the supporting pillars 16 and the engaging claws 18 (including the insertion holes 18B) are provided at the base 14, and the insertion pins 38 are provided at the base cover 36. However, the insertion pins 38 may be provided at the base 14, and the supporting pillars 16 and the engaging claws 18 (including the insertion holes 18B) may be provided at the base cover 36.

Further, in the above-described first embodiment through fourth embodiment, the vehicle camera devices 10, 60, 70, 80 are set at the side door 12 of a vehicle. However, the vehicle camera devices 10, 60, 70, 80 may be set at another portion (e.g., the fender) of a vehicle.

Moreover, in the above-described first embodiment through fourth embodiment, the mirror mechanism 48 is provided at the vehicle camera devices 10, 60, 70, 80. However, the mirror mechanism 48 does not have to be provided at the vehicle camera devices 10, 60, 70, 80. In this case, the entirety of the portion of the base 14 that is exposed from the vehicle body side may be covered by the base cover 36.

The disclosure of Japanese Patent Application No. 2019-234613 filed on Dec. 25, 2019 is, in its entirety, incorporated by reference into the present specification.

### EXPLANATION OF REFERENCE NUMERALS

10 . . . vehicle camera device, 12 . . . side door (vehicle body side), 14 . . . base (supporting body), 18 . . . engaging claw (engaging portion), 18B . . . insertion hole, 20 . . . camera mechanism. 26 . . . through-hole. 32A . . . lens, 36 . . . base cover (covering body), 38 . . . insertion pin (insertion portion), 40 . . . opening, 60 . . . vehicle camera device, 70 . . . vehicle camera device, 80 . . . vehicle camera device

1. A vehicle camera device comprising:
a supporting body that is supported at a vehicle body side, and at which is provided an engaging portion in which an insertion hole is provided;
a camera mechanism at which a lens is provided, and in which is provided a through-hole through which the engaging portion passes; and
a covering body at which is provided an insertion portion, which is inserted in the insertion hole such that the through-hole is positioned with respect to the engaging portion and the insertion portion is positioned with respect to the insertion hole, an opening being provided in the covering body, the covering body covering the camera mechanism, and the camera mechanism capturing images of an outer side of the opening through the lens.

2. A vehicle camera device comprising:
a supporting body that is supported at a vehicle body side, and at which an insertion portion is provided;
a camera mechanism at which a lens is provided and in which a through-hole is provided; and
a covering body at which is provided an engaging portion that is passed through the through-hole and in which an insertion hole is provided, an opening being provided in the covering body, the insertion portion being inserted in the insertion hole such that the insertion hole is positioned with respect to the insertion portion and the through-hole is positioned with respect to the engaging portion, the covering body covering the camera mechanism, and the camera mechanism capturing images of an outer side of the opening through the lens.

3. The vehicle camera device of claim 1, wherein a plurality of each of the engaging portion, the through-hole and the insertion portion is provided.

4. The vehicle camera device of claim 1, wherein the insertion hole and the through-hole are disposed coaxially.

5. The vehicle camera device of claim 1, wherein the engaging portion can elastically deform toward an insertion hole side, and the insertion portion is inserted in the insertion hole, such that elastic deformation of the engaging portion toward the insertion hole side is restricted.

6. The vehicle camera device of claim 1, wherein the engaging portion extends out from a supporting portion, a claw portion is provided at the engaging portion, and the camera mechanism is nipped between the supporting portion and the claw portion.

7. The vehicle camera device of claim 1, wherein sliding of the through-hole in a radial direction and an axial direction with respect to the engaging portion is restricted.

8. The vehicle camera device of claim 1, wherein rotation of the through-hole with respect to the engaging portion is restricted.

9. The vehicle camera device of claim 1, wherein sliding of the insertion portion in a radial direction with respect to the insertion hole is restricted.

10. The vehicle camera device of claim 1, wherein rotation of the insertion portion with respect to the insertion hole is restricted.

11. The vehicle camera device of claim 2, wherein a plurality of each of the engaging portion, the through-hole and the insertion portion is provided.

12. The vehicle camera device of claim 2, wherein the insertion hole and the through-hole are disposed coaxially.

13. The vehicle camera device of claim 2, wherein the engaging portion can elastically deform toward an insertion hole side, and the insertion portion is inserted in the insertion hole, such that elastic deformation of the engaging portion toward the insertion hole side is restricted.

14. The vehicle camera device of claim 2, wherein the engaging portion extends out from a supporting portion, a claw portion is provided at the engaging portion, and the camera mechanism is nipped between the supporting portion and the claw portion.

15. The vehicle camera device of claim 2, wherein sliding of the through-hole in a radial direction and an axial direction with respect to the engaging portion is restricted.

16. The vehicle camera device of claim 2, wherein rotation of the through-hole with respect to the engaging portion is restricted.

17. The vehicle camera device of claim 2, wherein sliding of the insertion portion in a radial direction with respect to the insertion hole is restricted.

18. The vehicle camera device of claim 2, wherein rotation of the insertion portion with respect to the insertion hole is restricted.
